(19) United States
(12) Patent Application Publication
(10) Pub. No.: US 2011/0016057 A1
(43) Pub. Date: Jan. 20, 2011

(54) ONLINE MUSIC WORKSHOP AND METHOD FOR IMPLEMENTING THE SAME

(76) Inventor: Matthew Jeremy Halpern, Baltimore, MD (US)

Correspondence Address: The Marbury Law Group, PLLC, 11800 SUNRISE VALLEY DRIVE, SUITE 1000, RESTON, VA, 20191, US

(21) Appl. No.: 12/836,680

(22) Filed: Jul. 15, 2010

Related U.S. Application Data
(60) Provisional application No. 61/226,623, filed on Jul. 17, 2009.

(51) Int. Cl. G06Q 50/00

(52) U.S. Cl. 705/326

(57) ABSTRACT

An online music workshop and method of implementing the same. A server device maintains a lessons calendar for an instructor. The lessons calendar may be generated by the server device from availability data relating to the instructor. The lessons calendar identifies blocks of time as available or unavailable. The server device receives a selection from a user of a user access device for an available block of time of the instructor. The server device may determine whether to schedule the selection for the user based on rules associated with the instructor. The server device may construct a unique identifier from the lesson information for use in billing a user for a lesson.

### RELATIONSHIP TO OTHER APPLICATIONS

This application claims the benefit of a provisional application 61/226,623 filed on Jul. 17, 2009, which application is incorporated herein in its entirety for all purposes.

### BACKGROUND

Experienced musicians often teach music lessons to students as a way to supplement their income. Presently, music teachers and students may have limited options for connecting in any way other than in-person. Music lessons alone are often not enough to support a musician and so musicians are forced to take other jobs to earn money.

Traditional in-person lessons, such as music lessons, may have certain other limitations including: periods of limited in-person instructor availability such as when a teacher is on tour with his/her band or other music group, limited free-time due to heavier vehicle traffic patterns and the resulting longer drive times, increased cost of driving to lessons for both students and teachers due to rising fuel prices, and limited availability for parents to drive music students to their lessons due longer working hours.

Conventional online lesson delivery systems may not be open to all teachers and students, may not be affordably priced, and may not permit a teacher to set his/her own rates for instruction. Moreover, conventional online lesson delivery systems do not provide fully interactive live lessons.

### SUMMARY

Embodiments herein are directed to an interactive online music lesson delivery system and method that permit a teacher to give lessons to students independent of the location of the teacher or student and at a time convenient to both.

### DESCRIPTION OF THE DRAWINGS

FIG. 1 is a block diagram illustrating an interactive music workshop system according to an embodiment.

FIG. 2 is a block diagram illustrating features of a workshop server 110 according to an embodiment.

FIG. 3 is a block diagram illustrating the features of a lessons module according to an embodiment.

FIG. 4 is a block diagram illustrating features of a sessions server according to an embodiment.

FIG. 5 is a flow diagram illustrating a method for online lesson delivery according to an embodiment.

FIG. 6 is a component block diagram illustrating a computing device suitable for use in the various embodiments.

### DETAILED DESCRIPTION

In an embodiment, an interactive music workshop system permits musicians and users to interact in various ways over a network.

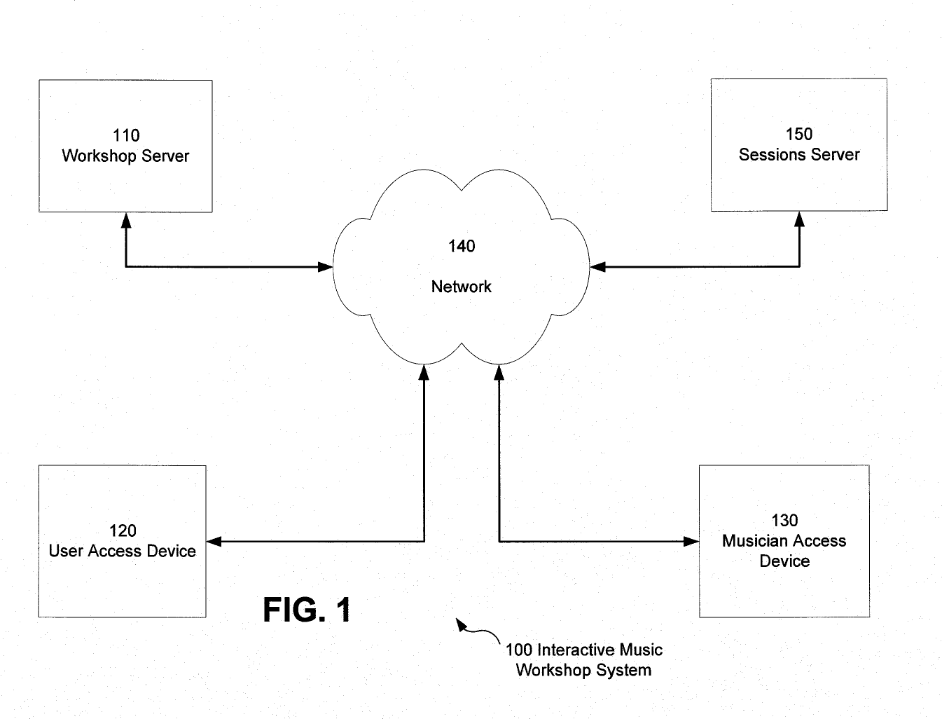

FIG. 1 is a block diagram illustrating an interactive music workshop system according to an embodiment.

According to an embodiment, an interactive music workshop system 100 comprises a workshop server 110, a user access device 120, a musician access device 130, and a sessions server 150 all connected via a network 140. While only a single user access device 120 and a single musician access device 130 are illustrated, this is not meant as a limitation. In practice, it is anticipated that any number of musicians and users may be interacting using the interactive music workshop system 100 at any one time.

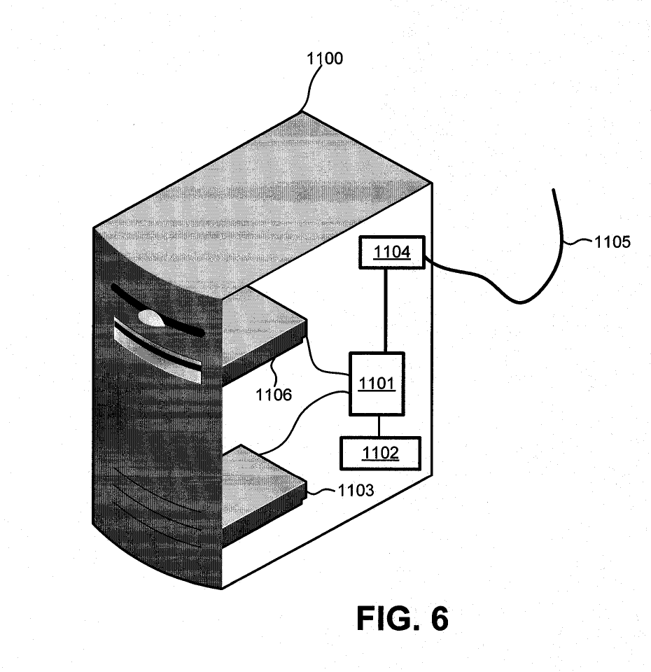

In an embodiment, the user and musician access devices comprise the features of a computing device as described below and illustrated in FIG. 6.

A user may access the interactive music workshop system 100 from a user access device 120 for any number of reasons. By way of illustration and not by way of limitation, a user may be an individual interested in music from an academic perspective, a user interested in following or interacting with a particular musician, or an individual interested in obtaining music lessons from a musician.

A musician may also access the interactive music workshop system 100 from a musician access device 130 for any number of reasons. By way of illustration and not by way of limitation, a musician may be a performer looking to interact with other musicians, a musician looking to audition for a particular position, or a teacher desiring to provide music lessons to a student.

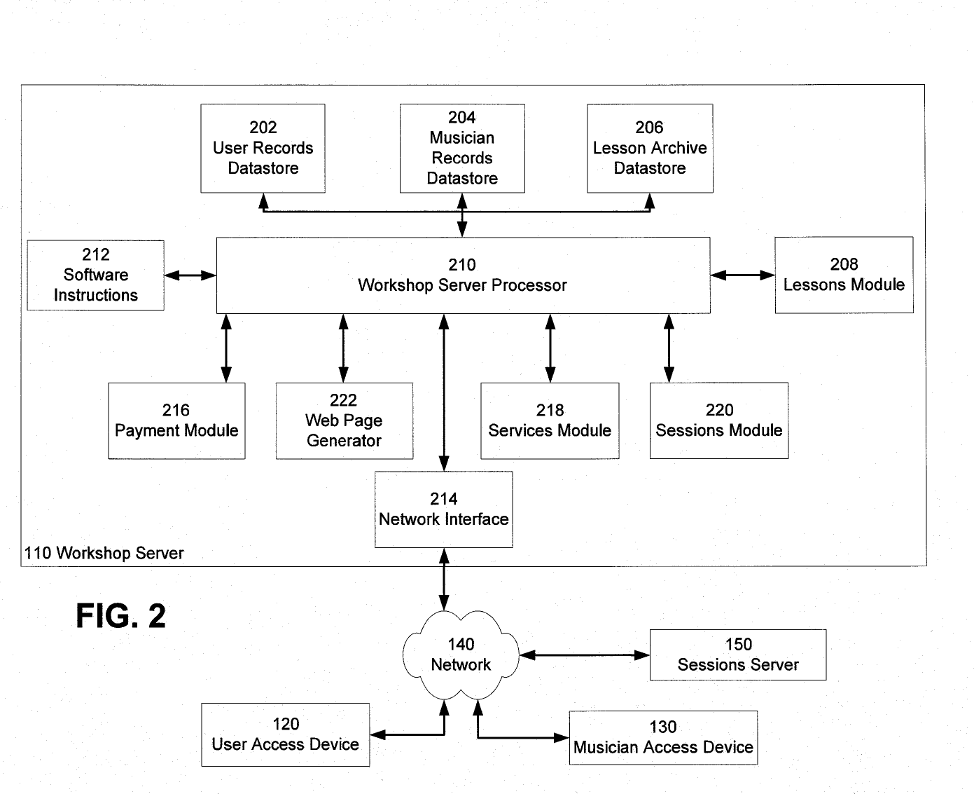

FIG. 2 is a block diagram illustrating features of a workshop server 110 according to an embodiment.

A workshop server 110 comprises a user records datastore 202, a musician records datastore 204, and a lesson archive datastore 206. Each of these datastores is accessible to a workshop server processor 210. The workshop server 110 also comprises a lessons module 208, a payment module 216, a services module 218 and a sessions module 220. Each of these modules is accessible to a workshop server processor 210. The workshop server processor 210 accesses software instructions 212 stored in memory and a network interface 214.

In an embodiment, the workshop server 110 further comprises a web page generator 222. The web page generator 222 generates web pages that may be served to a standard browser operating in the user access device 120 and the musician access device 130. In an embodiment, the web page generator 222 executes HTML code to produce web pages accessible to access devices. In another embodiment, the web page generator 222 comprises a PHP interpreter which interprets PHP code that is embedded into HTML source documents to generate a web page document. The web pages produced by the web page generator 222 may include data acquired from the data stores and/or generated by the modules that are components of the workshop server 110.

The network interface 214 provides the workshop server 110 to a network 140. In an embodiment, the network is the Internet. However, this is not meant as a limitation. The network 140 may be a private network that serves a community, an institution, a campus, or a facility. The network 140 may be a wired or wireless network. While the network 140 is illustrated as a unitary entity, this is not meant as a limitation. The network 140 may include any number of sub-networks that have been interconnected to provide a path to and from the components of the interactive music workshop system 100.

The user records datastore 202 comprises records that associate a particular user with user information. In an embodiment, the user record may include identifying information such as user name and password, preference information such as instruments that the user plays, musical genres, musicians and groups that the user prefers, payment information, access history, and profile-related information.

The musician records datastore 204 comprises records that associate a particular musician with musician information. In an embodiment, the musician record may include identifying information such as a musician name and password, instruments that the musician plays, groups and affiliations to which the musician belongs, recording history, instruments for which the musician is qualified to provide instruction, payment information, access history, and profile-related information. A musician may also post fan-related information, details of contests, and items for sale, among others.

The lessons archive datastore 206 comprises recordings of lessons relating to a musical topic. By way of illustration and not by way of limitation, a lesson may provide a course in music theory, a course in music history, a voice instruction, instruction in the playing of a musical instrument, recording “how-to,” songwriting/poetry, rapping/lyrics, classical music, songs, workshops, performance/showmanship, band practice, instrument tuning, teaching music, instrument practice, front man performance, music industry, music publishing, business management, music production/music videos, music promotion, street teams, website/Internet/online promotion, music history, recording tricks, marketing, showcasing, interviewing, business/band meetings, touring/tour management, among other possibilities. In an embodiment, a lesson may be provided for free or in exchange for a fee. In another embodiment, a user who has paid for a lesson session may access a recording of that lesson session via the archive datastore. Access to a recorded lesson stored in the lessons archive datastore 206 may require the presentation of identifying information. In another embodiment, a lesson session may be available only for a limited time after which time it is deleted from the lessons archive datastore 206.

The lessons module 208 comprises data structures and instructions to permit a user to schedule a live instructional session with a musician.

In an embodiment, a user operating a user access device 120 may interact with the workshop server 110 via web pages generated by web page generator 222. A user may navigate the workshop server 110 by selecting a link or a tab to invoke a function. By way of illustration and not by way of limitation, a user may select a “search” tab to search for a music instructor for a particular subject (Mozart, The Rolling Stones) or an instructor for a particular instrument (violin, guitar, drums). The web page generator 222 may return the results of a search using data stored in one or more of the datastores described above. The results may contain tabs or links that allow the user to select an instructor and to navigate to one or more additional pages to view the selected instructor's profile information, availability, rates, and ratings. Other searches may include a musician's performance schedule as stored in the musician record datastore 204 and recent lessons that have been added to the lessons archive datastore 206.

In another embodiment, a musician may select a “search” tab to search for users that have indicated an interest in a particular genre of music, in obtaining lessons for a particular subject (Mozart, The Rolling Stones) or for a particular instrument (violin, guitar, drums), or in a group to which the musician belongs. The web page generator 222 may return the results of a search using data stored in one or more of the datastores described above. The results may contain tabs or links that allow the musician to add the user to a “fan” list or to send a communication to the user.

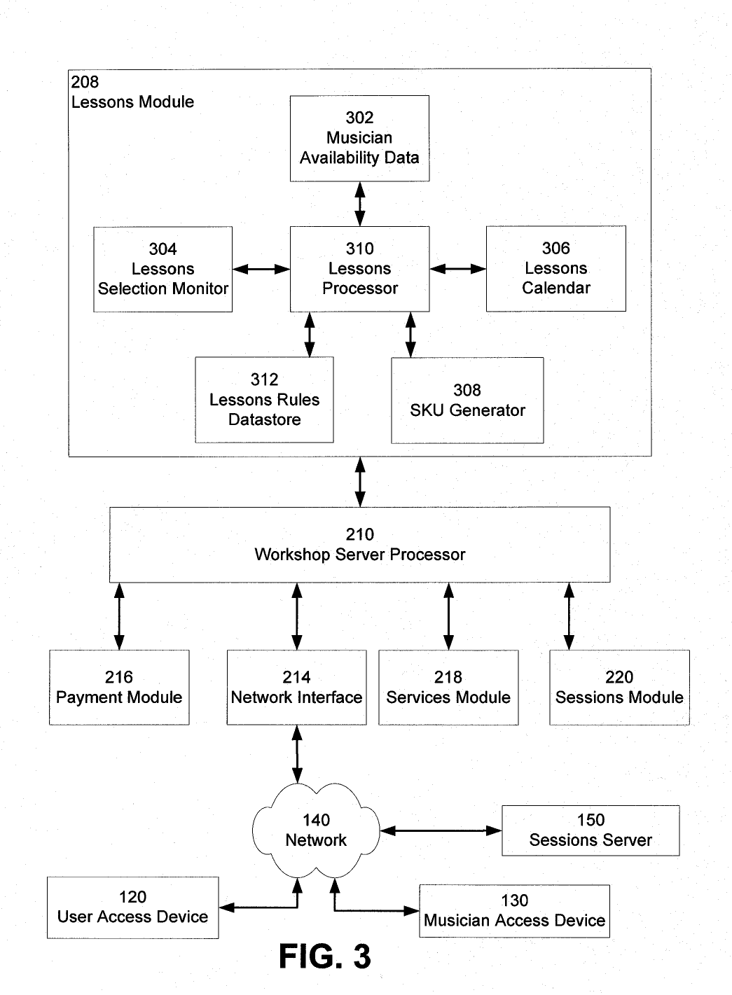

FIG. 3 is a block diagram illustrating the features of a lessons module according to an embodiment.

In an embodiment, the user access device 120 communicates via the network 140, the network interface 214, and the workshop server processor 210 to access the lessons module 208. The lessons module comprises a lessons processor 310 that operates on musician availability data 302 to maintain a lessons calendar 306 in real time. In an embodiment, the musician availability information for a particular musician may include the times and dates that the particular musician is available to provide a lesson. The musician availability information may also include a description of the lesson material, a rating of the material, and a disclaimer where appropriate. In another embodiment, the lessons processor 310 may operate on user information in the user information datastore 202 to determine whether the user is permitted to access content having a particular rating.

The user operating the user access device 120 may access the lessons calendar 306. The lessons calendar 306 displays the availability information 302 at the current time. The user may select a block of time comprising a start time and an end time on a particular date on which to schedule a lesson with a particular musician. A lessons selection monitor 304 detects the selection of the date and block of time and identifies it as committed time. The lessons processor 310 updates the musician availability data 302 of the particular musician and updates the lessons calendar 306 to reflect that the time block and the date have been scheduled.

In an embodiment, the selection of the time block and date by the user is subject to rules established by the musician. In this embodiment, before the user selection is identified as committed time, the lessons processor 310 applies the rules to the time block and the date. By way of illustration and not by way of limitation, a rule may be established that establishes a minimum duration of a lesson, a minimum and maximum period of time between a selected lesson start time and a preceding block of time that is unscheduled, a skill level of the user, a referral from another instructor, and a price to be paid for the lesson. The result of the application of the lesson rules by the lessons processor 310 may be communicated to the user access device 120 via a return path through the workshop server processor 210, the network interface 214, and the network 140. When the user's request violates a rule, a user may be given the opportunity to change his or her selection so as to meet the requirements of the rules. When the rule includes a price, the user may be required to accept the price and submit payment via the payment module 216 (described below) before user selection is identified as committed time.

In an embodiment, payment for a lesson is facilitated by an SKU generator 308. The SKU generator uses information about the lesson commitment to generate a unique transaction identifier that may be used to identify the lesson for billing and accounting purposes. By way of illustration and not by way of limitation, the SKU may be in the form of “teacher Jones@04202012:2:15-2:45 ET.” By generating the SKU dynamically based on action by a student, instructors are relieved of the obligation of generating SKUs for specific blocks of time, which in turns allows lesson time to be sold in user selected increments.

In an embodiment, the lessons module 208 interacts through the workshop processor 210 to notify the musician of the scheduling of a lesson. The notification may, for example, take the form of an e-mail, a text message, an audio message or an update to a Facebook or Twitter page. The notification may be handled via the services module 218. The musician may also check the lessons calendar 306 via the musician access device 130.

The sessions module 220 comprises software instructions that permit the workshop server processor 210 to establish a session with the sessions server 150. The sessions server 150 provides an audio and a video link between two or more participants in a live interaction. By way of illustration and not by way of limitation, a session may be established to conduct a music lesson, a lecture, a theory class, question and answer opportunity, an audition, a group practice session, a jam session, a demonstration, or an exhibition and instruction among others. A session may be a free event or it may require payment by some or all of the participants.

In an embodiment, the sessions module 220 provides authentication and identifying information of the participants to the sessions server 150 via the network 140 and then redirects the access devices of the participants to the sessions server. The sessions module 220 may direct the sessions server 150 to provide the sessions module 220 with a log of the session that may be used for billing purposes and for reestablishing a session should the session be terminated prematurely.

In an embodiment, the session will be torn down when all of the participating parties leave the session.

Referring again to FIG. 2, the payment module 216 presents payment options to users, accounts for payments due to musicians and refunds due to users, and distributes payments to accounts as appropriate. Payment options may include credit cards, debit cards, checks, third party payment systems (for example, Paypal, Google Checkout, Amazon Payments), and prepaid accounts that are maintained on the workshop server 110. In an embodiment, the payment module 216 associates payment with an SKU that is generated by the SKU generator 308 in response to user interaction with a lessons module 208. The SKU and the payment are then associated with an account of the particular musician or group that is providing the lesson associated with the SKU. In another embodiment, a user may be offered the opportunity to include a tip with the payment of a fee.

In an embodiment, the lessons module 208 may direct the web page generator 222 to generate a page requesting feedback from a user following the completion of a lesson. A teacher's ratings may be public (e.g., visible to users of the system including prospective students) or may be private (visible only to the teacher).

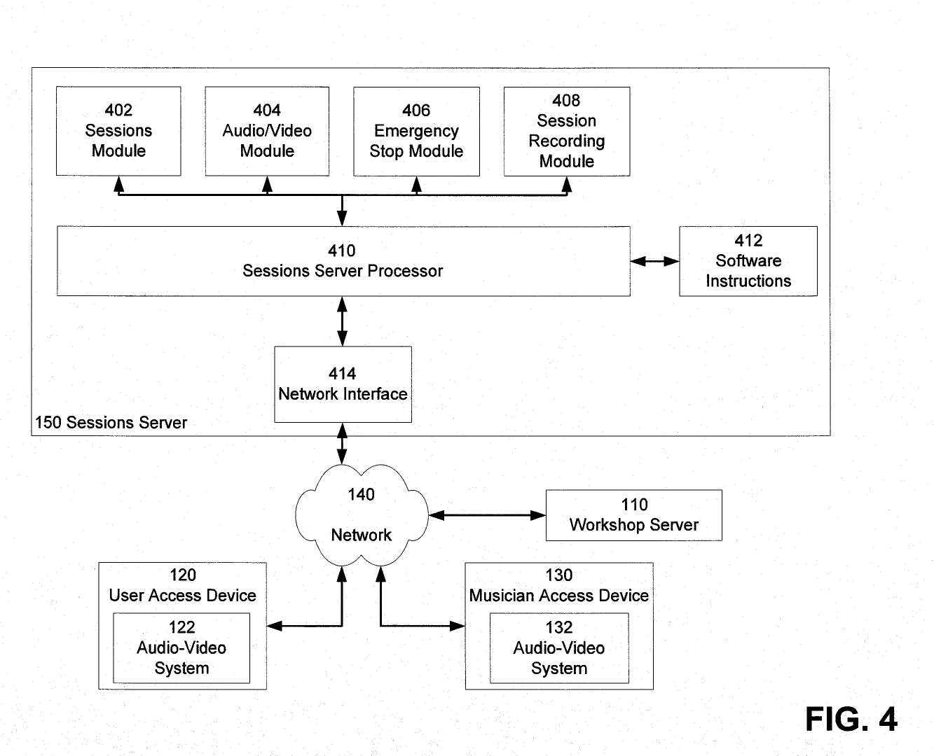

FIG. 4 is a block diagram illustrating features of a sessions server according to an embodiment.

A sessions server 150 comprises a sessions module 402, an audio/video module 404, an emergency stop module 406 and session recording module 408. Each of these modules is accessible to a sessions server processor 410. The sessions server processor 410 accesses software instructions 412 stored in memory and a network interface 414. The software instructions 412 allow the sessions server processor to establish communications with the workshop server, perform the housekeeping that may be necessary to operate a session, and perform the housekeeping that may be necessary to tear down a session when the session is terminated.

The sessions module 402 of the sessions server 150 communicates with the sessions module 220 to manage sessions between and among user access devices 120 and musician access devices 130. In operation, the sessions server 150 in cooperation with the workshop server 110 may facilitate “live” audio and video communications to a single user and a single musician, multiple users and a single musician, multiple musicians (no “users”), or a single user and multiple musicians. Stated differently, music lessons can be given as private teacher to student lessons (one-to-one), band to student private lesson (many-to-one), band member to student private lesson (one-to-one), private group lessons (one-to-many), public group lessons (one-to-all), private workshops (one-to-many), or public workshops (one-to-all). Additionally, lessons can be given in a band-to-band or multiple teacher-to-multiple student format (many-to-many).

A session may facilitate a private lesson, a non-private group lesson, a demonstration, a lecture, or a performance or trailer inviting users or musicians to schedule a formal session. Participation in a session may be free or require payment of a fee. A musician participating in a non-private group lesson or other “pay-to-view” session may receive a percentage of the participation fees.

The sessions server 150 may provide user participants the opportunity to communicate with the musician participant or participants via text, video or audio. By way of illustration and not by way of limitation, participants may communicate via a chat function provided by the sessions module 402 or by the software instructions 412.

In another embodiment, during a session provided by the sessions server 150, the workshop server may present notation, tab, rhythm, and other instructional material to the sessions server 150 for delivery to the user participant during the session.

The audio-video module 404 of the sessions server 150 manages the audio and video data streams generated by the audio-video system 122 residing in the user access device 120 and the audio-video system 132 residing in the musician access device 130. These data streams are combined to provide a user with an audio-video signal that is returned to the user access device 120 and a musician audio-video signal that is returned to the musician access device 130. In an embodiment, the audio and video streams generated by the audio-video module 404 of the sessions server 150 utilize a Flash Media Live Encoder.

In an embodiment, the signal that is sent to the user access device 120 provides the user an image and audio generated by the musician audio-video system 132. The image generated by the user audio-video system 122 may not be visible to the user of the user access device 120.

In an embodiment, the signal that is sent to the musician access device 130 provides the musician an image and audio generated by the user audio-video system 122. The image generated by the musician audio-video system 132 may not be visible to the user of the musician access device 130.

In an embodiment, when multiple users and/or multiple musicians are participating in a session, the user audio-video display signal and the musician audio-video display signal comprise icons representing the participants in the session. Selection of an icon by a user or a musician causes an image of the participant represented by the selected icon to be displayed on the appropriate access device.

In an embodiment, a session recording module 408 generates recordings of sessions for subsequent storage in the session archive datastore 206 of the workshop server 110. The session recording module 408 may record a session in one format and then provide it to the workshop server in another format. In another embodiment, the session recording module 408 adds a watermark to the video recording to help identify the source of any unauthorized use, display or distribution of a recorded session.

In an embodiment, an emergency stop module 406 monitors an emergency stop “button” or link (not illustrated) that may be activated by either a user or a musician. By way of illustration, an emergency stop may be activated when one of the participants engages in offensive conduct, uses offensive language, or otherwise engages in conduct that at a minimum should not be available for viewing by other users or musicians. When activated, the emergency stop module 406 communicates with the session recording module 408 to flag the session recording for permanent archival status and to limit access to individuals with authority to view flagged recordings. The emergency stop module may also notify a designated individual or individuals that an emergency condition arose during a session. The notification may, for example, take the form of an e-mail, a text message, or an audio message. The notification may be handled via the services module 218 (described below).

In an embodiment, the sessions module 220 may direct the web page generator 222 to generate a page requesting feedback from a user following the completion of a session.

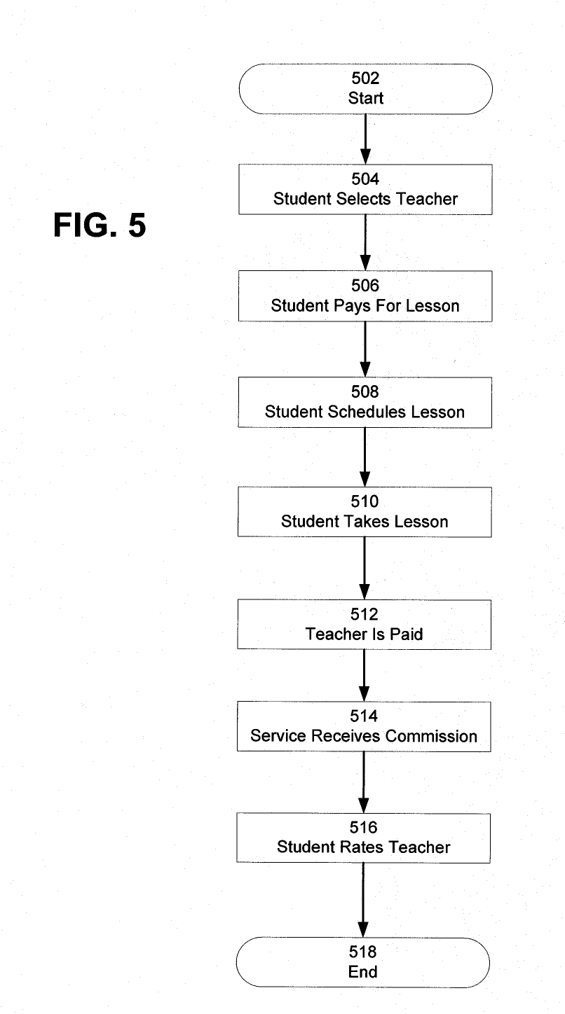

FIG. 5 is a flow diagram illustrating a method for online lesson delivery in accordance with an embodiment.

Processing begins at block 502 and continues to block 504.

At block 504, a student selects a teacher. Processing continues to block 506.

At block 506, the student pays for a lesson. The online music lesson delivery system can process the payment and credit appropriately as described herein. Processing continues to block 508.

At block 508, the student schedules the lesson. The lesson can be scheduled using an interactive calendar or live calendar as described herein. Processing continues to block 510.

At block 510, the student takes the lesson. The teacher delivers the lesson to the student using a system as described herein. Processing continues to block 512.

At block 512, the teacher is paid for giving the lesson. The payment can be distributed as described herein. Processing continues to block 514.

At block 514, the online music lesson delivery service optionally receives a portion of the lesson fee as a commission. The service may receive a commission for paid lessons (fee or tip), but may not receive a commission for a free lesson. Processing continues to block 516.

At block 516, the student optionally rates the teacher according to one or more criteria. The rating or feedback of the teacher may be public or private as described herein. Processing continues to block 518, where processing ends.

It will be appreciated that blocks 502-518 may be repeated, in whole or in part, in order to accomplish a contemplated online music lesson delivery task. Also, while FIG. 5 has been described in terms of a one-to-one private lesson, a similar procedure can be followed for group lessons, master classes, and live performances (where each student pays for and receives the group lesson, master class or views the live performance). Also, while described for illustration purposes in terms of teacher/student, the process of FIG. 5 is also applicable to bands and fans.

As will be appreciated by those of ordinary skill in the art, the interactive music workshop system 100 may be utilized to perform a variety of functions. By way of illustration and not by way of limitation:

A band may sell tickets to live performances broadcast from anywhere a suitable Internet connection is available. Musicians may perform on their instruments live from anywhere a suitable Internet connection is available.

Additionally, fans may create events to help promote bands, musicians, and raise money for charity. Teachers may use the interactive music workshop system 100 to promote themselves and gain students.

Teachers may also organize live recitals for their students. The recitals may be viewed by anyone permitted access to the recital. For example, a music student may allow parents, grandparents, relatives, and friends to view the live recital. This feature allows distant relatives or friends to be a part of the audience for the student's recital.

A performer, a group or band may offer live practices, presenting live shows, tour diaries/backstage footage, live auditions, writing sessions, poetry readings, new songs, and cover songs.

Users may be invited to participate in an “open mic” session and in multi-player jam sessions.

A contest may be offered on a periodic basis such as daily, weekly, monthly, or the like. Contests may be offered on a paid, free, subscription, tip basis, or the like. Contests may include, but are not limited to, battle of the bands, songwriting, rap battles, poetry readings, instrument competitions, opening band competitions, jingles, best of genre, best promo materials, biggest fan, rider scavenger hunts, funniest musician, focus groups, and/or the like.

A performer or band may initiate a “Bring the Rider” on a paid, free, subscription or tips basis. In an embodiment including a “bring the rider” feature, bands may sign up to allow their fans to supply their riders while on tour and create a checklist with what they need and fans fill in slots. Fans may register and compete to bring rider materials for bands on tour (in-person); fans may also register on a first-come, first-serve basis or may participate in the “Bring the Rider” Scavenger Hunt Contest. Rider materials include food and beverage, after-party materials (e.g., for fans 21+ or of the appropriate legal age in their jurisdiction for the material being provided), extra gear, repairs for instruments, lodging, clothing, bedding (pillows, blankets, etc.), entertainment (games, magazines, music, DVDs, or the like), and cameras/film.

Using the musician records datastore 204, a musician or group may publicize upcoming events, availability to perform at certain functions, compensation requirements, and other promotional information. The promotional information may be available for searching by other musicians and users. For example, an individual or group may indicate the type of function they are available for such as parties, charity events, weddings, bar mitzvahs, and/or the like. A musician may publicize availability for studio work for hire in which the online music lesson delivery system may be utilized to send recorded music over the Internet or the music may be recorded in person. Also, the availability/need of other services may be publicized such as songwriting/jingles, filming, recording, live sound, tour ride-along, merchandise, promotion, street teams, roadies, tour managers, managers, booking agents, public relations, marketing, and the like. An embodiment may include a feature for auditioning prospective members for bands and other “gigs” (i.e., work/performance opportunities) such as cover and acoustic gigs.

A musician or group may provide other users and musicians access to a personal online store on a paid, free, subscription, fee, tip or royalty basis. An online store may include archived lessons and performances, instruments, repairs, books, photo albums, magazines, music services (e.g., studio work, hired gun, songwriting, publishing, or the like), jingles and other publishable works, books and music for teaching, educational DVDs and videos, band merchandise, teacher merchandise, fan merchandise, music, videos, and music memorabilia associated with the musician or group.

Using the services module 218, musicians and users may access social networking features on a free or paid basis. Social networking features include member profiles with standard social networking functions (messaging, picture and video uploads, ability to add “friends,” friend lists, bulletins, etc.). In addition to standard social networking features, an embodiment may include a “For Hire” feature for display on a user's profile. An embodiment may permit users to store and showcase content (e.g., video, music, merchandise, images, promo materials, or the like) and make content available publicly or only to those users permitted to view the profile.

The social networking features may be used to provide a blogging feature that, in addition to standard blogging features, permits users to customize their blog, create your topic, give music education, and provide performances. A blog entry may be published to a site-wide blog for rating, tips, etc.

The social networking features may be used to allow users to post songs/lyrics to their profile for lyric and songwriting competitions.

The social networking features may be used to also provide features for live video chat built into each member profile so that users may chat or perform live any time (student-to-student, teacher-to-teacher, band-to-band, or any other combination). Additionally, users who take lessons from the same musician may utilize the social networking features.

The social networking features may be used to permit bands to network with each other for tours, compilations, live shows online, competitions, and to find new band members, songwriters and/or promoters.

The social networking features may be used to provide a reputation management/rating system for all users (e.g., content to better promote lessons, performances, and for-hire work).

The social networking features may be used to include social networking features for tagging content by genre, style, instrument, favorite bands, cover songs, merchandise, blog, phototags, or the like such that a site-wide search facility may be provided to search the tags or fields.

The social networking features may be used to provide a “live” calendar to display a schedule of live lessons, performances, workshops, master classes, contests, and the like. An embodiment may include social networking features to display this calendar on a user's profile or publish entries to a site-wide calendar. An embodiment may include features to display a resume or a profile for teachers, bands, musicians, promoters, or anyone for hire.

The social networking features may be used to provide customizable play lists for music streaming. Users may upload their own music or music from other musicians and bands. Users may use these features to promote themselves or their favorite artists. Uploaded music or playlists may be made available on a user's profile or published site-wide.

The social networking features may be used to provide ongoing user groups and forums (e.g., to contribute to making the site better, discourage defectors, monitor lessons or performances, be part of focus groups with bands, or the like).

An industry and artist directory may be provided which may include a rating system of the artists.

Using the services module 218, promotional technology features may be provided on a free or paid basis. Promotional technologies may include a flyer and image maker (e.g., in which users upload photos, text, music, etc. to make online or printable promotional flyers for lessons, performances, shows, master classes, contests, or the like. Promotional technologies may also include a merchandise generator (e.g., a system in which users create, promote and sell their own customizable merchandise using a system operating similar to those available from zazzle.com among others). Promotional technologies also include a music video editing and production application (e.g., which may use on-site and off-site videos and music to create promotional videos for users, fans, bands, teachers, or the like which may be used as tour DVDs, tour diaries, promotional reels, or the like. Promotional technologies also include a newsletter co-generation for cross-marketing of bands, teachers, or the like, (e.g., users share flyers, promo materials and videos, merchandise or the like). Promotional technologies also include music publishing and copyrighting capabilities (e.g., similar to capabilities offered by rumblefish.com).

A number of the embodiments described above may also be implemented with any of a variety of computing devices, such as the computing device 1100 illustrated in FIG. 6. Such a computing device 1100 typically includes a processor 1101 coupled to volatile memory 1102 and a large capacity nonvolatile memory, such as a disk drive 1103. The computing device 1100 may also include a floppy disk drive and/or a compact disc (CD) drive 1106 coupled to the processor 1101. The computing device 1100 may also include network access ports 1104 coupled to the processor 1101 for establishing data connections with network circuits 1105 over a variety of wired and wireless networks using a variety of protocols.

While the computing device 1100 is illustrated as using a desktop form factor, the illustrated form is not meant to be limiting. For example, some or all of the components of computing device 1100 may be implemented as a desktop computer, a laptop computer, a mini-computer, a smartphone, a personal data assistant or a custom-built appliance.

The foregoing method descriptions and the process flow diagrams are provided merely as illustrative examples and are not intended to require or imply that the blocks of the various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an,” or “the,” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The blocks of a method or algorithm disclosed herein may be embodied in a processor-executable software module, which may reside on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein but is to be accorded the widest scope consistent with the following claims and the principles and novel features disclosed herein.

What is claimed is:

1. A system for providing lessons over a network comprising:
a network;
a user access device connected to the network;
a server device connected to the network, wherein the server device comprises a processor configured with instructions that cause the server device to perform operations comprising:
receiving availability data relating to an instructor;
maintaining a lessons calendar for the instructor using the availability data, wherein the lessons calendar identifies blocks of time as available or unavailable;
receiving a selection from a user of the user access device for an available block of time of the instructor;
receiving lesson information;
generating a unique identifier from the lesson information; and
sending the unique identifier to a billing system.

2. The system of claim 1, wherein the instructor provides instruction in a subject selected from the group consisting of playing an instrument, music theory, music history, song writing, lyric writing, poetry writing, and music business management.

3. The system of claim 1 further comprising a rules datastore, wherein the rules datastore comprises rules established for the instructor, and wherein the processor is further configured with instructions that cause the server device to perform operations comprising:
accessing the instructor rules in the rules datastore;
applying the rule to the selection of the available block of time;
determining whether the selection of the available block of time complies with the instructor rules; and
associating the selected block of time with the user and identifying the selected block of time as unavailable when the selection of the available block of time complies with the instructor rules.

4. The system of claim 3, wherein the rule establishes conditions selected from the group consisting of a minimum duration of a lesson, a minimum and maximum period of time between a selected lesson start time and a preceding block of time that is unscheduled.

5. The system of claim 3, wherein the rule establishes conditions selected from the group consisting of a skill level of the user wherein the processor is further configured with instructions that cause the server device to perform operations comprising acquiring information about the skill level of a user of the user access device.

6. The system of claim 3, wherein the processor is further configured with instructions that cause the server device to perform operations comprising sending a communication to the user access device when the selection of the available block of time does not comply with the instructor rules, wherein the communication provides one or more reasons why the selection of the available block of time does not comply with the instructor rules.

7. The system of claim 6, wherein the processor is further configured with instructions that cause the server device to perform operations comprising receiving a revised selection from the user of the user access device.

8. The system of claim 3, wherein the instructor rule comprises a price for the selected block of time and wherein determining whether the selection of the available block of time complies with the instructor rules comprises receiving payment of the price from the user.

9. The system of claim 3, wherein the processor is further configured with instructions that cause the server device to perform operations comprising notifying the instructor when the selected block of time is unavailable.

10. The system of claim 9, wherein the notification is provided in a form selected from the group consisting of an e-mail, a text message, an audio message and an update to a web page.

11. The system of claim 1, wherein the system further comprises an instructor access device and wherein the processor is further configured with instructions that cause the server device to perform operations comprising establishing a session with a sessions server to form a video and audio link between the user access device and the instructor access device.

12. The system of claim 1, wherein the lesson information comprises an instructor name and a time and date of the selected block of time.

13. A method for providing lessons over a network comprising:
a server device receiving availability data relating to an instructor;
the server device maintaining a lessons calendar for the instructor using the availability data, wherein the lessons calendar identifies blocks of time as available or unavailable;
the server device receiving a selection from a user of a user access device for an available block of time of the instructor;
the server device receiving lesson information;
the server device generating a unique identifier from the lessons information; and
the server device sending the unique identifier to a billing system.

14. The method of claim 13, wherein the instructor provides instruction in a subject selected from the group consisting of playing an instrument, music theory, music history, song writing, lyric writing, poetry writing, and music business management.

15. The method of claim 13 further comprising:
the server device accessing an instructor rule in a rules datastore;
the server device applying the rule to the selection of the available block of time;
the server device determining whether the selection of the available block of time complies with the instructor rules; and
the server device associating the selected block of time with the user and identifying the selected block of time as unavailable when the selection of the available block of time complies with the instructor rules.

16. The method of claim 15, wherein the rule establishes conditions selected from the group consisting of a minimum duration of a lesson, a minimum and maximum period of time between a selected lesson start time and a preceding block of time that is unscheduled.

17. The method of claim 15, wherein the rule establishes conditions selected from the group consisting of a skill level of the user and wherein the method further comprises the server device acquiring information about a user of the user access device to assess the skill level of the user.

18. The method of claim 15 further comprising the server device sending a communication to the user access device when the selection of the available block of time does not comply with the instructor rules, wherein the communication provides one or more reasons why the selection of the available block of time does not comply with the instructor rules.

19. The method of claim 18 further comprising receiving a revised selection from the user of the user access device.

20. The method of claim 15, wherein the instructor rule comprises a price for the selected block of time and wherein determining whether the selection of the available block of time complies with the instructor rules comprises receiving payment of the price from the user.

21. The method of claim 15 further comprising notifying the instructor when the selected block of time is unavailable.

22. The method of claim 21, wherein the notification is provided in a form selected from the group consisting of an e-mail, a text message, an audio message and an update to a web page.

23. The method of claim 13, wherein the method further comprises establishing a session with a sessions server to form a video and audio link between the user access device and an instructor access device.

24. The method of claim 13, wherein the lesson information comprises an instructor name and a time and date of the selected block of time.
